(19) United States
(12) Patent Application Publication
(10) Pub. No.: US 2012/0169938 A1
(43) Pub. Date: Jul. 5, 2012

(54) Automatic Mute Control

(76) Inventor: Ray Harvey, Lakeland, FL (US)

(21) Appl. No.: 12/984,795

(22) Filed: Jan. 5, 2011

(51) Int. Cl. H04N 5/44

(52) U.S. Cl. 348/734; 348/E05.097

(57) ABSTRACT

An automatic mute control comprising a control box attached to a cable box, where the control box is configured to mute a television connected to the cable box; a signal window attached to a front portion of the control box, where the signal window receives a set of signals; a remote control, where the remote control enables a user to manually operate the control box by sending the set of signals; and a detector circuit housed within the control box, wherein the detector circuit recognizes when a commercial airs on the television thereby activating the control box to mute the volume of the television until the commercial finishes.

### BACKGROUND OF THE INVENTION

1. Field of the Invention

The present invention relates to a device that automatically mutes a television when a commercial airs and then automatically resumes the television programming once the commercial is finished.

2. Description of Related Art

Most people have at least one television in their home and watch hours of programming each day. The television shows and movies provide an entertaining outlet for the viewers. The shows may range fun entertaining sporting events, educational documentaries or hilarious comedies. While some viewers enjoy the group television watching experience, many others simply watch television as a relaxing way to wind down their day.

A common nuisance involves the numerous commercials that air during the viewer's favorite programs. Unless the viewer is watching a premium channel program the viewer is bombarded with loud and obnoxious commercials that may interrupt the relaxing mood that the viewer was experiencing. When the commercials air, the viewer must search for their remote, lower the television volume and then increase the television volume when the regular programming airs. Often the viewer misses a portion of the returned programming because their attention may be distracted during a commercial and consequently fails to timely increase the volume. The relaxed setting, preferred by the viewer, may be frequently interrupted because the viewer must continuously lower and increase their television volume.

It would be beneficial in the art to provide a device that automatically adjust the volume of a television when a commercials air. It would also be desirable to include a feature that allows the viewer to override the auto feature so that the viewer maintains continuous control of their viewing entertainment.

### SUMMARY OF THE INVENTION

An object of the present invention is to provide an automatic mute control that detects when a commercial airs, then automatically mutes the television and finally resumes the original volume setting when the commercial ends.

Another object of the present invention is to provide a remote control that manually overrides the automatic features of the automatic mute control to provide continuous control to the viewer.

In view of the foregoing disadvantages inherent in the prior art, the present invention provides an automatic mute control comprising a control box attached to a cable box, where the control box is configured to mute a television connected to the cable box; a signal window attached to a front portion of the control box, where the signal window receives a set of signals; a remote control, where the remote control enables a user to manually operate the control box by sending the set of signals; and a detector circuit housed within the control box, wherein the detector circuit recognizes when a commercial airs on the television thereby activating the control box to mute the television until the commercial finishes.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, wherein like elements are identified with like symbols, and in which:

FIG. 1 depicts a perspective view of an automatic mute control according to an exemplary embodiment of the present invention.

### DETAILED DESCRIPTION OF THE DRAWINGS

The present invention relates to a device that automatically mutes a television when a commercial airs and then automatically resumes the television programming once the commercial is finished. The present invention provides an automatic mute control that includes a control box that is programmed to detect commercials and mute a television, and a remote control to manually activate the control box. The control box automatically detects commercials and the audio component from the television is temporarily disabled until the regular programming resumes. The automatic mute control requires no codes or special programming, and does not require any changes until the unit is moved to a different television set, making it a practical tool for enhancing any television viewing experience.

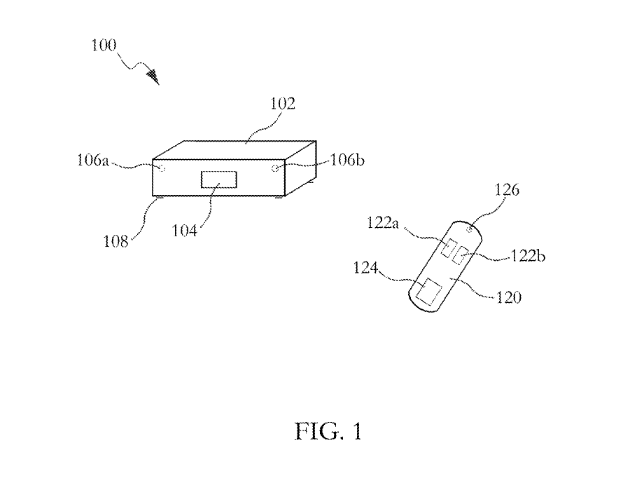

Tuning now descriptively to the drawings, referring to FIG. 1, a perspective view of an automatic mute control (100) is shown in accordance with an exemplary embodiment of the present invention. The automatic mute control (100) may include a control box (102) to house a plurality of electrical components. The control box (102) connects to a set of audio feeds of a cable box for a television. The control box (102) includes a detector circuit which is programmed to recognize when a commercial airs on the television. When a commercial comes on the television the detector circuit sends a signal through the control box (102) to disable an audio signal from the cable box. The detector circuit essentially mutes the television when the commercial is on. When the commercial or series of commercials are finished the detector circuit allows the audio signal to resume the original volume setting.

The automatic mute control (100) may comprise two components including a control box (102) and a remote control (120). Attached to a front wall of the control box (102) may be a signal window (104). The signal window (104) may receive a mute signal from the remote control (120) to deactivate the audio signal from the cable box. The signal window (104) may be a glass or a plastic cover that enables the mute signal to pass through while still providing a protective covering for the front wall of the control box (102). Fastened to an underside of the control box (102) may be a set of feet (108). The set of feet (108) elevate the control box (102) to enable air to flow beneath the control box (102), and prevent heat from building within the plurality of electrical components.

Additionally, positioned to a set of upper corners of the control box (102) may be s set of indicators (106a, 106b). The indicators (106a, 106b) may be a set of LED lights that illuminate with specific triggers. In the upper left corner may be a power indicator (106a) to notify a user when the control box (102) is on. In the upper right corner may be an in-use indicator (106b) to inform the user when the control box is currently muting the television. The in-use indicator (106b) illuminates when the control box (102) mutes the television and accordingly deactivates when the television resumes audio control.

The remote control (120) coordinates with the control box (102) to power and activate the detector circuit. The remote control (120) allows the user to manually activate and deactivate the control box (102) thereby providing an override to the automatic features of the detector circuit. The remote control (120) may include a set of buttons (122a, 122b) to send a set of signals to the control box (102). A first button may be a power button (122a) which sends a power signal to the control box (102). When the power button (122a) is pressed it sends the power signal through the signal window (104) to activate the control box (102), and in turn the power indicator (106a) illuminates. A second button may be an activation button (122b) to manually activate the control box (102) to mute the television. As such, when the activation button (122b) is pressed it activates an activation signal through the signal window (104), and the in-use indicator (106b) illuminates.

On a top portion of the remote control (120) may be a signal indicator (124). The signal indicator (124) may be an LED light that illuminates whenever the power button (122a) or the activation button (122b) is pressed. Within a bottom portion of the remote control (120) may be a battery compartment (126) to hold a set of batteries.

In an additional embodiment of the automatic mute control the detector circuit may be constructed or incorporated directly into the cable box. In this embodiment a separate control box is not necessary. The detector circuit may be built within the cable box at the manufacturing company therefore providing the automatic mute feature as an additional accessory feature of the cable box. The automatic mute feature may be incorporated into a range of cable boxes and audio entertainment centers to provide a more enjoyable viewing experience for all viewers.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An automatic mute control comprising:
a control box attached to a cable box, where said control box is configured to mute the volume of a television connected to said cable box;
a signal window attached to a front portion of said control box, where said signal window receives a set of signals;
a remote control, where said remote control enables a user to manually operate said control box by sending said set of signals; and
a detector circuit housed within said control box, wherein said detector circuit recognizes when a commercial airs on said television thereby activating said control box to mute the volume of said television until said commercial finishes.

2. The automatic mute control according to claim 1, wherein said control box includes a set of indicator lights.

3. The automatic audio control according to claim 2, wherein said set of indicator lights include a power indicator and an in-use indicator.

4. The automatic audio control according to claim 3, wherein said power indicator notifies said user when said control box is on, and said in-use indicator notifies said user when said control box is muting the volume of said television.

5. The automatic audio control according to claim 1, wherein said remote control includes a set of buttons.

6. The automatic audio control according to claim 5, wherein said set of buttons activate said plurality of signals to operate said control box.
